(19) United States
(12) Patent Application Publication
(10) Pub. No.: US 2020/0320561 A1
(43) Pub. Date: Oct. 8, 2020

(54) METHOD AND APPARATUS USING CONTEXT TO DETERMINE CONSUMER DEALS

(71) Applicant: Groupon, Inc., Chicago, IL (US)

(72) Inventors: Sean O'Brien, Fremont, CA (US); Ramkumar RAJENDRAN, Santa Clara, CA (US); Mark DALY, San Francisco, CA (US); Xiaolei LI, Sunnyvale, CA (US); Kevin CHANG, Mountain View, CA (US); Ruslan GILFANOV, Mountain View, CA (US); Stanley WANG, Mountain View, CA (US); Amit AGGARWAL, Los Altos, CA (US); David THACKER, Burlingame, CA (US); Michalis POTAMIAS, San Francisco, CA (US)

(21) Appl. No.: 16/904,152

(22) Filed: Jun. 17, 2020

Related U.S. Application Data
(62) Division of application No. 13/411,502, filed on Mar. 2, 2012, now abandoned.

(51) Int. Cl. G06Q 30/02

(52) U.S. Cl. CPC G06Q 30/0224; G06Q 30/0239; G06Q 30/0236; G06Q 30/0222

(57) ABSTRACT

Provided herein are a method and apparatus configured to determine one or more consumer deals to present to a consumer. The method and apparatus may include receiving contextual data; accessing one or more databases containing consumer deals; determining a context under which to present a consumer deal to a consumer, the determined context selected from a plurality of contexts; selecting a set of workflow rules under which to determine the consumer deal to present to the consumer; analyzing the plurality of consumer deals based at least in part on the selected set of workflow rules; determining a selected consumer deal to present to the consumer; generating an electronic correspondence comprising the selected consumer deal; and transmitting the electronic correspondence to the consumer device for presenting the selected consumer deal to the consumer.

### CROSS-REFERENCE TO RELATED APPLICATIONS

The present application is a divisional of U.S. application Ser. No. 13/411,502, filed Mar. 2, 2012, which is incorporated by reference herein in its entirety.

### 1. TECHNICAL FIELD

The present description relates to offering promotions or deals associated with a product or a service. This description more specifically relates to relevance system for determining which promotion(s) or deal(s) to offer for a product or a service.

### 2. BACKGROUND

Merchants typically offer promotions to consumers. The promotions offered may be in the form of discounts, rewards, or the like. When offering the promotions, a merchant may seek to focus the offer to a subset of its consumers. In order to select those consumers in the subset, the merchant may analyze data generated from similar promotions. However, the analysis to determine which promotion(s) or deal(s) to offer to the consumer for a product or a service may prove difficult.

### SUMMARY

A relevance system and method is disclosed.

According to another embodiment of the invention, a system and method is disclosed for determining which of a plurality of consumer deals to present to a consumer. The plurality of consumer deals may be for goods and or for services. In one aspect, a method is provided that includes: accessing, in at least one memory, consumer data associated with the consumer; accessing, in the at least one memory, deal data associated with the plurality of consumer deals; scoring the plurality of consumer deals by using part or all of the consumer data and part or all of the deal data; re-scoring the plurality of consumer deals using the same or different consumer data used to score the plurality of consumer deals; and determining, using at least one processor, which of the plurality of consumer deals to present to the consumer based on the re-scoring of the plurality of consumer deals. The same or different user data may be used to score the plurality of consumer deals as to re-score the plurality of consumer deals. Further, the same or different deal data may be used to score the plurality of consumer deals as to re-score the plurality of consumer deals. For example, consumer location data may be used to score the plurality of consumer deals, and to re-score the plurality of consumer deals. As another example, user data other than user previous purchase data may be used to score the plurality of consumer deals, and user previous purchase data may be used to re-score the plurality of consumer deals. Further, the scoring of the plurality of consumer deals may be performed using a scoring model, and the re-scoring may be done without a different model or with a correction factor. Alternatively, the scoring of the plurality of consumer deals may be performed using no scoring model (such as a correction factor), and the re-scoring may be done using a scoring model.

In another aspect, a system is provided that includes at least one processor and at least one memory, wherein the at least one processor is in communication with the at least one memory. The at least one processor, when executing instructions that may be stored in the memory, is configured to: access, in the at least one memory, consumer data associated with the consumer; access, in the at least one memory, deal data associated with the plurality of consumer deals; score the plurality of consumer deals by using part or all of the consumer data and part or all of the deal data; re-score the plurality of consumer deals using the same or different consumer data used to score the plurality of consumer deals; and determine, using at least one processor, which of the plurality of consumer deals to present to the consumer based on the re-scoring of the plurality of consumer deals.

According to yet another embodiment of the invention, a system and method is disclosed for determining which of a plurality of consumer deals to present to a consumer. In one aspect, the method includes: accessing, in at least one memory, consumer data associated with the consumer, the consumer data including consumer location data; accessing, in the at least one memory, deal data associated with the plurality of consumer deals; scoring, by at least one processor, at least one of the consumer deals using the consumer location data; scoring, by the at least one processor, at least another of the consumer deals without using the consumer location data; and determining which of the plurality of consumer deals to present to the consumer based on the scoring of the at least one of the consumer deals and the scoring of the at least another of the consumer deals. In this way, the method may examine both deals that are location dependent and deals that are not location dependent. For example, the method may evaluate service deals that are location dependent and online deals for hard goods that are not location dependent. As another example, the method may evaluate different types of travel deals. One type of travel deal may be considered a driving type travel deal, in which the consumer drives to the travel deal. Another type of travel deal may be considered a flying type travel deal. The method may determine which type is the travel deal based on a distance to travel to the deal (such as less than 200 miles is considered a driving type travel deal and greater than or equal to 200 miles is considered a flying type travel deal). The driving type travel deal may account for the driving distance in determining whether to present the deal to the user, whereas the flying type travel deal may not account for the flying distance in determining whether to present the deal to the user. Moreover, the scoring of the location dependent deal and the location independent deal may be iterative, so that an initial score may be generated, and re-scored one or multiple times prior to determining whether to present the consumer deal to the consumer.

In another aspect, a system is provided that includes at least one processor and at least one memory, wherein the at least one processor is in communication with the at least one memory. The at least one processor, when executing instructions that may be stored in the memory, is configured to: access, in at least one memory, consumer data associated with the consumer, the consumer data including consumer location data; access, in the at least one memory, deal data associated with the plurality of consumer deals; scoring, by at least one processor, at least one of the consumer deals using the consumer location data; score, by the at least one processor, at least another of the consumer deals without using the consumer location data; and determine which of the plurality of consumer deals to present to the consumer based on the scoring of the at least one of the consumer deals and the scoring of the at least another of the consumer deals.

According to still another embodiment of the invention, a system and method is disclosed for determining which of a plurality of consumer deals to present to a consumer. In one aspect, a method is provided that includes: determining, using at least one processor, a context under which to present at least one of the plurality of consumer deals to the consumer, the determined context selected from a plurality of contexts; and in response to determining the context, selecting a set of rules under which to determine which of the plurality of consumer deals to present to the consumer. Different contexts include, but are not limited to: all deals context (e.g., examining all deals regardless of the device that receives the consumer deal); mobile context (e.g., a mobile device, such as a smartphone, that receives the consumer deal); getaways context (e.g., evaluates travel deals); goods context (e.g., evaluates hard good deals); occasions context; search engine marketing context (e.g., evaluating deals based on input from a search engine); zero day context (e.g., when it is determined that the consumer has not purchased his or her first deal, the set of deals examined for the consumer may be different from the set of deals examined by a consumer that has purchased a previous deal); and post purchase context (e.g., the same day that a consumer purchases a deal, such as in the same hour, or less than 5 minutes after purchase of a deal, the consumer is presented with at least one additional deal based on the same day purchased deal).

Other systems, methods, and features will be, or will become, apparent to one with skill in the art upon examination of the following figures and detailed description. It is intended that all such additional systems, methods, features and be included within this description, be within the scope of the disclosure, and be protected by the following claims.

### BRIEF DESCRIPTION OF THE DRAWINGS

The relevance system may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 shows a representation of a network and a plurality of devices that interact with the network, including the relevance system.

FIG. 2A shows a block diagram of the relevance system.

FIG. 2B shows a block diagram of the context determination and the different context workflows.

FIG. 3 shows a block diagram of the deal analytical engine.

FIG. 4 shows a block diagram of the user, deals, feature extractor and scoring/ranking model.

FIG. 5 shows an expanded block diagram of the scoring/ranking model illustrated in FIG. 4.

FIG. 6 is a logic flow of the one aspect of the logic used by the relevance system.

FIG. 7 shows a logic flow of the relevance system logic in which multiple types of geographic data are analyzed.

FIG. 8 shows a logic flow of the relevance system logic in which different parts of the user data are analyzed.

FIG. 9 shows a logic flow of the relevance system logic in which purchase history of the user is analyzed.

FIG. 10 shows another example of the logic flow of the relevance system.

FIG. 11 shows a block diagram of batch processing for the relevance system.

FIG. 12 shows a logic flow of the getaways context workflow of the relevance system.

FIG. 13 shows a block diagram of the search engine context workflow of the relevance system.

FIG. 14 is a general computer system, programmable to be a specific computer system, which may represent any of the computing devices referenced herein, such as the relevance system.

### DETAILED DESCRIPTION

The principles described herein may be embodied in many different forms. Not all of the depicted components may be required, however, and some implementations may include additional, different, or fewer components. Variations in the arrangement and type of the components may be made without departing from the spirit or scope of the claims as set forth herein. Additional, different or fewer components may be provided.

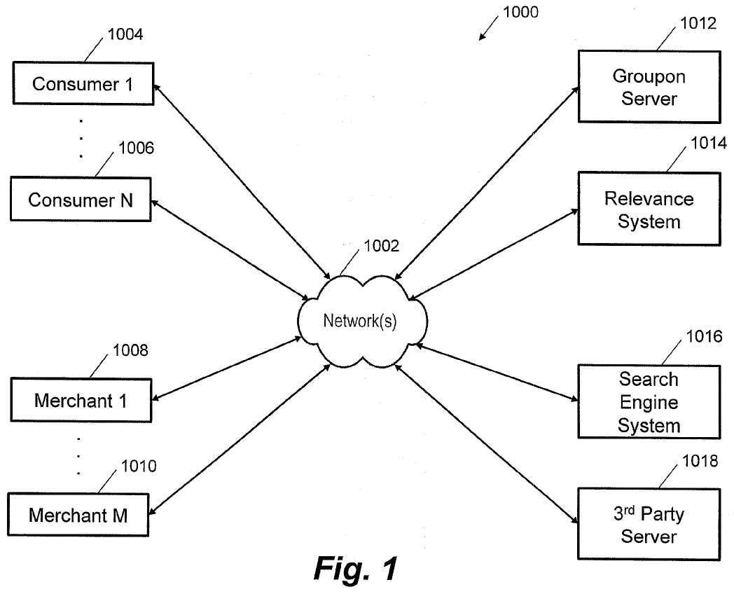

FIG. 1 illustrates a network architecture for a retailing system that includes relevance system 1014 and network 1002. The network 1002 may include one or more wired networks, wireless networks, or combinations thereof. The wireless network may be a cellular telephone network, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols.

Relevance system 1014 communicates with a variety of devices include consumer devices, merchant devices, servers (including servers that provide search engine capabilities and other website functionality). For example, one or more consumers, illustrated as Consumer 1 (1004) to Consumer N (1006), may communicate with network 1002. The consumers may use any type of electronic device, such as a mobile computing device (e.g., a smartphone), a palmtop computer, a laptop computer, a desktop computer, or the like. In addition, one or more merchants, illustrated as Merchant 1 (1008) to Merchant M (1010), may communicate with network 1002. The depiction in FIG. 1 of “N” consumers and “M” merchants is merely for illustration purposes.

FIG. 1 further illustrates servers, such as Groupon® server 1012 and 3^{rd} party server 1018, and network functionality, such as search engine system 1016. As illustrated in FIG. 1, relevance system 1014 is depicted separately from Groupon® server 1012. Alternatively, relevance system 1014 may be integrated with Groupon® server 1012.

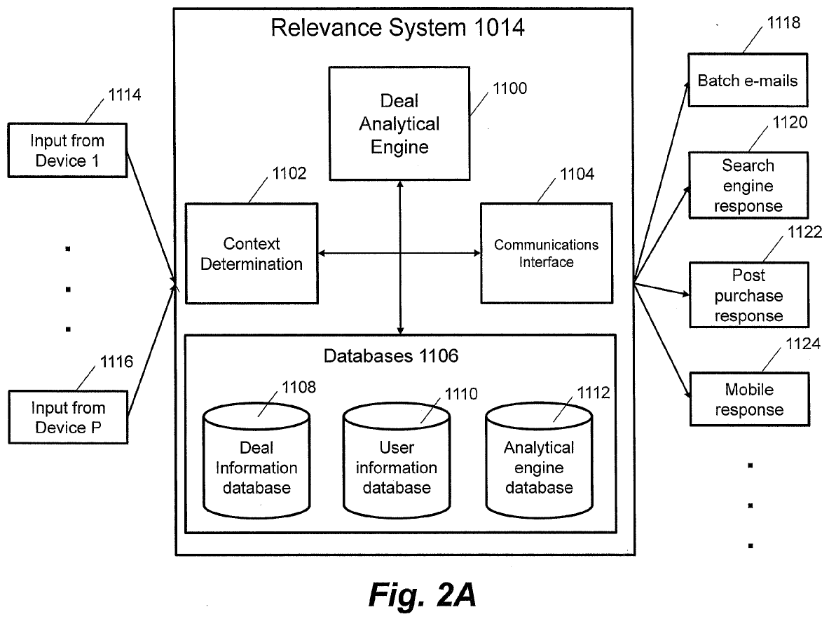

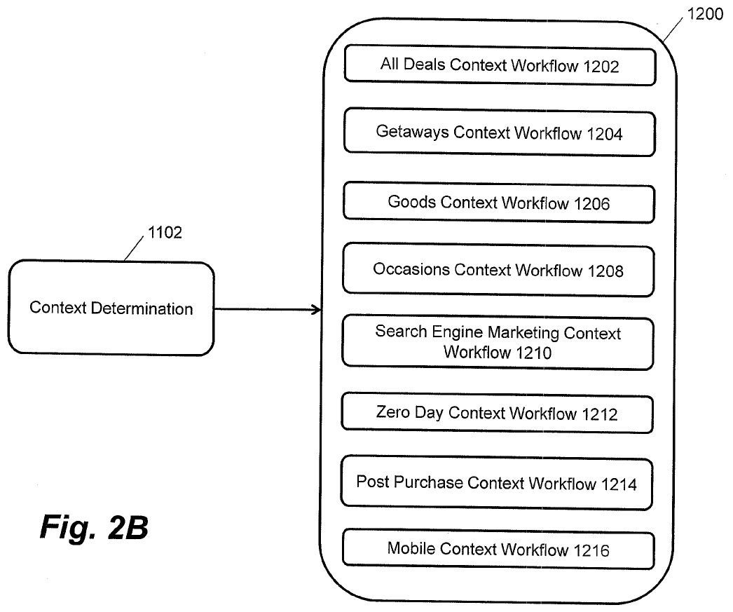

FIG. 2A illustrates an expanded block diagram of relevance system 1014. As illustrated in FIG. 2A, relevance system 1014 may receive inputs from one or more input devices, such as input from Device 1 (1114) to input from Device P (1116). Examples of input device include, but are not limited to input from Groupon® server 1012, search engine system 1016, 3^{rd} party server 1018, consumer 1 (1004) to consumer N (1006).

As shown in FIG. 2A, relevance system 1014 includes deal analytical engine 1100, context determination 1102, communications interface 1104, and databases 1106. In one embodiment, relevance system 1014 may optionally use context determination 1102 in order to process multiple workflows depending on the context. As shown in FIG. 2A, context determination 1102 is separate from deal analytical engine 1100, and may be used to control the flow of the various workflows. Alternatively, context determination 1102 may be integrated with deal analytical engine 1100. Further, as shown in FIG. 2A, databases 1106 include deal information database 1108, user information database 1110, and analytical engine database 1112. The deal information database 1108 includes data related to the deals available for offer to users. Deals include, but are not limited to, any type of reward, discount, coupon, credit, voucher or the like used toward part (or all) of the purchase of a product or a service. The user information database 1110 includes data related to the users. And, the analytical engine database 1112 includes data (other than deal data and user data) that is used by the deal analytical engine 1100, such as the past purchase database. FIG. 2A depicts deal information database 1108, user information database 1110, and analytical engine database 1112 as separate databases. Alternatively, deal information database 1108, user information database 1110, and analytical engine database 1112 may be included in a single memory device.

One example of context determination 1102 is illustrated in FIG. 2B, in which the context determination 1102 determines which of the following workflows 1200 to execute including: all deals context workflow 1202; getaways context workflow 1204, goods context workflow 1206, occasions context workflow 1208, search engine marketing context workflow 1210, zero day context workflow 1212, post purchase context workflow 1214, and mobile context workflow 1216. The workflows illustrated in FIG. 2B are merely for illustration purposes. Further, the workflows illustrated in FIG. 2B may use a single deal analytical engine 1100, which may be tailored to each of the specific contexts. Alternatively, one, some, or all of the workflows may have assigned to them a specific deal analytical engine.

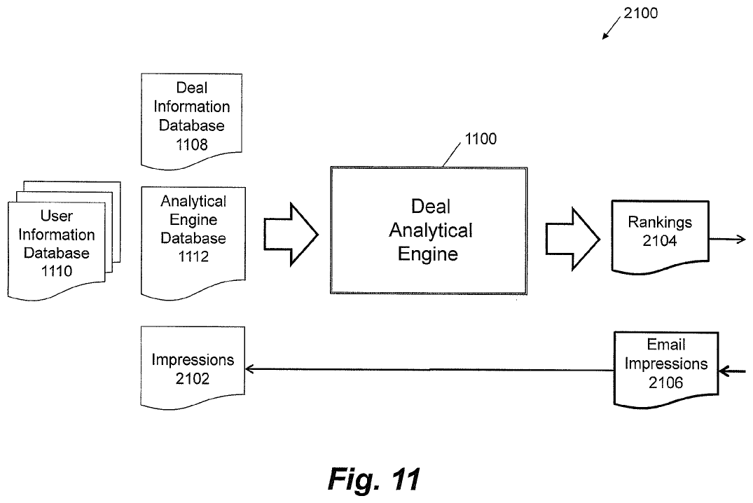

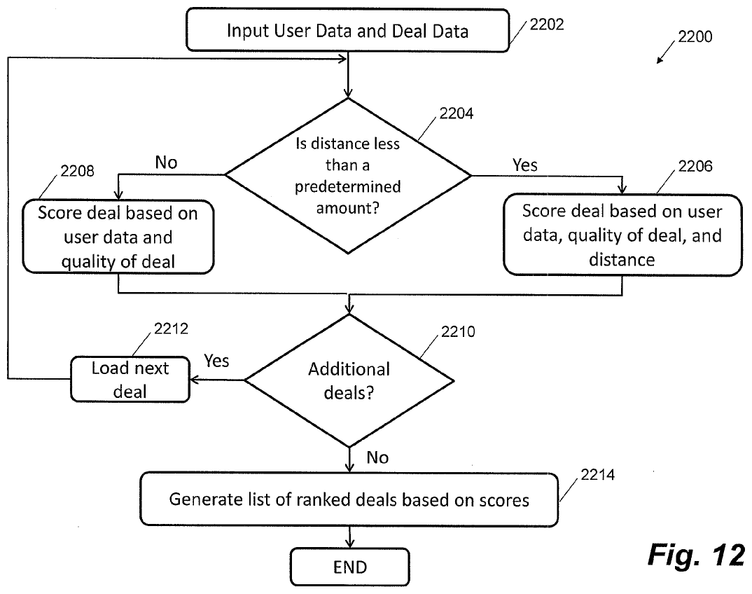

The workflows vary from one another in at least one aspect. For example, all deals context workflow 1202 relates to processing batch e-mails, such as described below with respect to FIG. 11. The search engine marketing context workflow 1210 relates to processing an inquiry from a search engine, such as described below with respect to FIG. 12. The getaways context workflow 1204, goods context workflow 1206, occasions context workflow 1208, zero day context workflow 1212, post purchase context workflow 1214, mobile context workflow 1216 are described below.

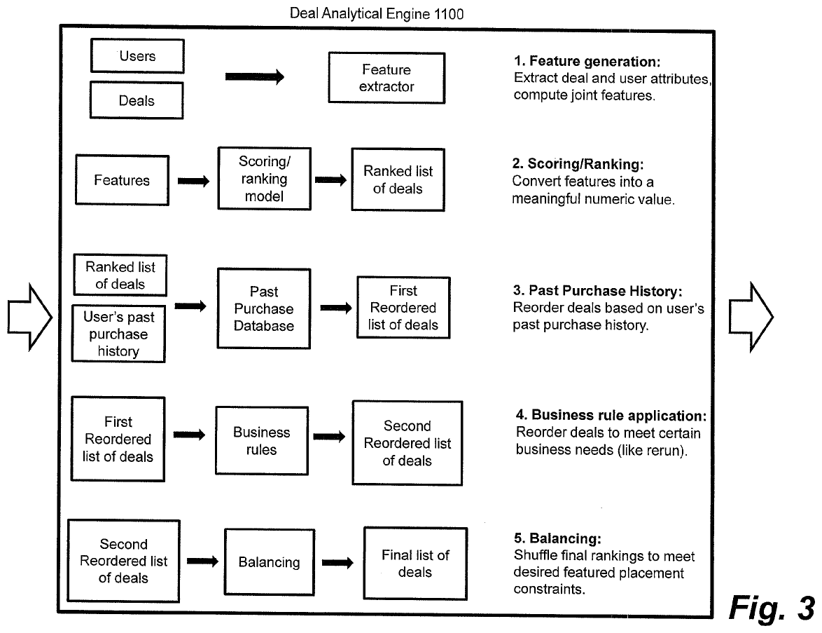

FIG. 3 illustrates an expanded block diagram of deal analytical engine 1100. Deal analytical engine 1100 analyzes multiple deals and user data in order to recommend one (or a list) of deals to present to a user. In this way, the deal analytical engine 1100 may support multiple ranking algorithms, so that the selected algorithm may be chosen at runtime. Further, the present configuration enables flexibility in terms of configuring additional contexts.

In one aspect, the deal analytical engine 1100 iteratively scores deals and/or ranks a list of deals. The deal analytical engine 1100 accesses multiple deals, and generates initial scores for the multiple deals and/or an initial ranking of the multiple deals. Thereafter, the deal analytical engine 1100 adjusts the initial scores for the multiple deals and/or the initial ranking of the multiple deals at least once (and potentially multiple times). The deal analytical engine 1100 may adjust the scores and/or the rankings of the deals in one or multiple ways. For example, the deal analytical engine 1100 may use one or more correction factors in order to alter the initial scores or subsequent scores for the multiple deals and/or the initial ranking of the multiple deals or subsequent ranking(s) of the multiple deals. As another example, the deal analytical engine 1100 may use one or more rules in order to adjust the initial scores, the subsequent scores, the initial ranking of the multiple deals, or the subsequent ranking(s) of the multiple deals (such as by excluding a deal based on a business rule).

In adjusting the initial scores, the subsequent scores, the initial ranking and/or the subsequent ranking(s), the deal analytical engine 1100 may analyze user data and/or deal data. For example, the deal analytical engine 1100 may analyze user data during one scoring or one ranking of the multiple deals and analyze user data (or a different type of user data) during a subsequent scoring or a subsequent ranking.

The user data analyzed by the deal analytical engine 1100 may be the same type of user data in the different scoring or ranking iterations. For example, the deal analytical engine 1100 may analyze a first type of geographic data in order to generate scoring for the multiple deals or one ranking of the multiple deals, and may analyze a second type of geographic data in order to generate subsequent scoring or a subsequent ranking. In particular, the deal analytical engine 1100 may use distance of the user to a deal location in order to generate the initial scores for the multiple deals or an initial ranking of the multiple deals, and use the location of the user in a city in order to determine whether to modify the initial scores or to adjust the initial ranking of the multiple deals.

Alternatively, the deal analytical engine 1100 may analyze different types of user data in the different scoring or ranking iterations. For example, the deal analytical engine 1100 may analyze user data that does not include user past purchase history in order to generate scoring for the multiple deals or one ranking of the multiple deals, and may analyze user past purchase history in order to generate subsequent scoring or a subsequent ranking (such as using past purchase history to modify the scores or to adjust an initial ranking of the deals). As another example, the deal analytical engine 1100 may analyze user data that does not include user deal type preference(s) in order to generate scores for the multiple deals or one ranking of the multiple deals, and may analyze user deal type preference(s) in order to generate subsequent scoring or a subsequent ranking. As still another example, the deal analytical engine 1100 may analyze user data that does not include any aspect of user interest in order to generate scores for the multiple deals or one ranking of the multiple deals, and may analyze user interest (such a user's open rate of previous e-mails and/or a user's click rate of links) in order to generate subsequent scoring or a subsequent ranking.

As discussed above, the deal analytical engine 1100 may adjust the scoring or the ranking of the multiple deals by analyzing deal data. The deal data analyzed by the deal analytical engine 1100 may be the same type of deal data and/or a different type of deal data in different scoring or ranking iterations. For example, the deal analytical engine 1100 may analyze deal data that does not include price of the deal in order to generate one set of scores or one ranking of the multiple deals, and may analyze price of the deal in order to generate a different set of scores or a subsequent ranking (such as using price of the deal to modify the one set of scores or to adjust an initial ranking of the deals).

FIG. 3 depicts various stages of operation of the deal analytical engine 1100. Stage 1 comprises feature generation, in which one or more features of both the user and the deals are extracted by a feature extractor in order to generate joint features. In the case of evaluating which deal (or deals) to offer to a single user, the user's particular features may be extracted. In the case of batch processing in which a deal (or deals) are evaluated in order to decide which to offer to a set of users (such as users that have agreed to receive a daily e-mail), the features for each of the users is extracted.

As discussed above, user data and deal data may be input and considered by the relevance system. The user data may include user data from a user profile. Examples of user features include, but are not limited to: location; gender; age; tenure; email domain; purchase history; email interaction; and mobile locations. For example, the user may input various aspects about the user himself or herself (such as age, gender, location, etc.), or may input various aspects of the deals that the user wishes to obtain. More specifically, the user may input the various locations associated with the user (such as the user's home, the user's work, etc., as discussed below) or the various locations that the user will be or frequents (such as in a particular location). Optionally, in addition, the user may input the times/dates when the user will be at the various locations. As discussed in more detail below, the relevance system may use the locations provided by the user in order to determine which deals to send (such as using the distance between a potential deal and one of the various locations in order to determine whether to send the deal). Further, the user may indicate a frequency by which to send deals and/or a list of attributes for the deals. The frequency may be daily, multiple times daily (such as 9:00 am and 6:00 pm daily), weekly (such as every Friday), or the like.

The user may also input various aspects of the desired deal, such as the deal types (such as indicating interest in newer deals, kids deals, grooming deals, health deals, recently issued deals, or other deals in different themes), the categories and/or subcategories of the deals, the price range of the deal, the division in which the deal is offered (such as a specific city in which the deal is offered), etc. The deal types may be mapped to various categories and/or subcategories of deals. A category of a deal may be defined as a classification of a deal (such as restaurant deals, spa deals, etc.). A subcategory may comprise a more granular classification of the category (such as Italian restaurant, Greek restaurant, etc.).

Other features of the user may be set without input from the user. For example, tenure is an indication of the length of time a user has been a Groupon® subscriber. Another example of features that are not directly set by the user are email domain features. The user may provide his or her email address. Based on the domain of the email address (such as Gmail®, Hotmail®, AOL®, etc.), the relevance system may infer certain characteristics. For example, a AOL® user tends to be older whereas a Gmail® user tends to be younger.

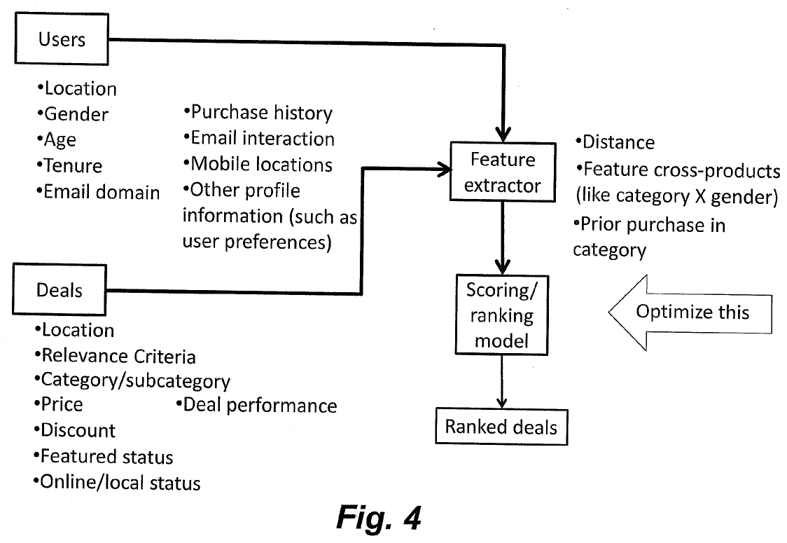

FIG. 4 also illustrates examples of deal features including, but not limited to: location; relevance criteria; category; price; discount; featured status; online/local status; and deal performance. The various features may be used to select the deal, as discussed in more detail below. For example, price is an indication of the price of the deal. As another example, relevance criteria are an indication of the specific criteria for target of the deal. In particular, the relevance criteria may be used to select a particular distance (or radius) from the deal. In this way, the relevance criteria can indicate to the relevance system the criteria under which to offer the deal to a user (such as a user being within a predetermined radius from the location of the deal).

As still another example, the featured status is an indication of a specific status. In particular, for a local deal, a specific deal may be selected as a “feature” deal for each city for a particular day. In turn, this is the deal that is shown at the top of the email and the website for users for which there is no personalization information. Specifically, if the relevance system does not know anything about a user's location, gender, etc., then the relevance system selects the featured deal that the user will see. For travel deals (such as in the getaways context, discussed below) and product deals (such as in the goods workflow context, discussed below), multiple deals may be marked as featured deals. The marking of the multiple deals may be manual, or automatic based on the deals that are considered the best in terms of at least one criterion. Further, the featured deals may be ranked above non-featured deals.

As one example, the feature extractor may extract the distance between the user and the deal, feature cross-products (such as a 2 dimensional analysis of category X gender), and a prior user's purchases in a category, as illustrated in FIG. 4. As another example, the feature extractor may extract the age, gender of users, extract the deal category of the multiple deals, and calculate the distance between the users and the multiple deals. The features extracted may be input to the scoring/ranking algorithm, which outputs a list of ranked deals.

As illustrated in FIG. 3, stage 2 comprises scoring/ranking, in which the features are input to a scoring/ranking model. The scoring/ranking model may be configured to score the plurality of deals based on what it is believed that the user's seeks (whether based on explicit input by the user what the user seeks in a deal and/or based on certain attributes of the user). In the instance where the user selects certain attributes of desired deals, the selected attributes of the desired deals may be used at different points in the relevance system determination process. For example, the scoring/ranking model may select only the deals that meet the attributes as selected by the user. So that, the entire universe of deals for scoring/review by the relevance system may be dictated by the user. As another example, the relevance system may factor in the user's desired attributes at a later point. In particular, the relevance system may weigh the score depending on the desired user attributes (such as improving the score of a deal that is characterized as a “family deal” if the user has selected as a deal attribute “family deals” type). In addition to using the desired attributes as selected by the user, the relevance system may examine other attributes of the user and attributes of the plurality of deals, such as listed in FIG. 4, to score the plurality of deals. If the user has not indicated a set of desired attributes, the relevance system may examine attributes of the user in the user profile, such as listed in FIG. 4, in order to evaluate which deals to select for notification.

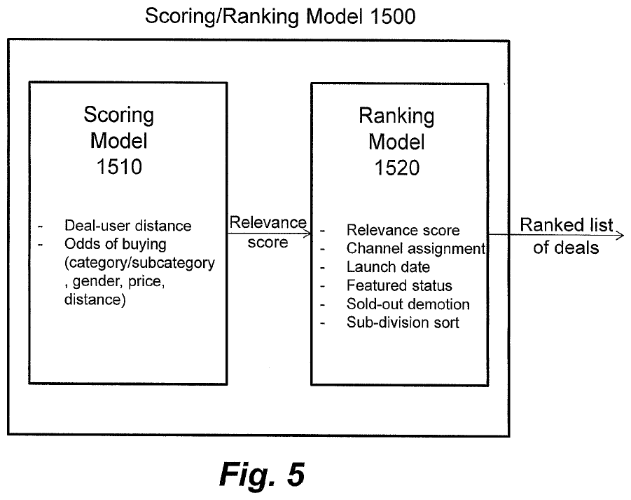

The scoring/ranking model then outputs a ranked list of deals. FIG. 5 illustrates an expanded block diagram of the scoring/ranking model 1500. The scoring/ranking model 1500 may be divided into a scoring model 1510 and a ranking model 1520.

The scoring model 1510 is configured to predict the likelihood that a user will accept a deal that is offered to the user. The indication of acceptance of the deal, according to the scoring model 1510, may take one of several forms, such as the conversion rate (the rate by which a user accepts a deal that is offered or the number of purchases of the deal divided by the number of times the deal is offered to users) or another type of relevance score. The scoring model 1510 may be organized into different categories of users correlated with different categories (and subcategories) of deal types. For example, the scoring model 1510 may aggregate the historical data from previously-run deals and/or historical data from the deal under consideration, organizing features of users (such as gender and distance from a deal) with the conversion rates for categories/subcategories of deals. In particular, the scoring model 1510 may be segmented by users (such as males 0-2 miles from the deal, males 2-4 miles from the deal, etc.) and segmented by deals in different categories/subcategories (such as the category of restaurants, and the subcategories of Italian restaurants, Greek restaurants, etc.). The scoring model 1510 aggregates the data from the previous deals in order to generate the conversion rates for the users in the different categories (such as the conversion rate for users that are males 2-4 miles from a Greek restaurant deal in Chicago). The examples of the categories of users and the categories/subcategories of deals are merely for illustration purposes only. Other categories are contemplated. For example, the categories of users may be subdivided into gender, distance, and age. As another example, the scoring model 1510 may be subdivided based on price of the deal. The results of the scoring model 1510 may be input to the ranking model 1520, which may generate a ranked list of deals according to the results.

Thus, the results of the scoring/ranking model 1500 may generate a ranked list of deals, which may thereafter be iteratively re-ranked according to further analysis of user data and/or deal data. Alternatively, the scoring model 1510 may output the scores for the multiple deals, and the scores may be iteratively modified (such as re-scored). After the final iteration, the scores may then be used to generate a final ranking of some or all of the deals in order to determine what deal(s) to present to the user.

FIG. 3 illustrates various iterations, such as past purchase history, business rule application, and balancing. The iterations (in the number of iterations, in the type of iterations, and in the sequence of iterations) are merely for illustration purposes. Other numbers, types and sequences of iterations are contemplated.

As shown in FIG. 3, the first iteration may account for the user's past purchase history by accessing a past purchase database in order to generate a first reordered list of deals. Alternatively, the user's past purchase history may be used to modify the initial scores. For example, the past purchase database may be part of the user information database 1110 and indicate which categories (or subcategories) of deals that the particular user previously purchased. The fact that the particular user has (or has not) previously purchased may be used in order to reorder the ranked list of deals. For example, the ranked list of deals for the particular user may include the top “X” deals, with each of the top “X” deals having a particular category and subcategory. In the event that the user has previously purchased a deal in a subcategory for one (or more) of the top “X” deals, the scores associated with those deals may be modified (such as by multiplying the score with a previous-purchase correction factor). Alternatively or in addition, in the event that the user has not previously purchased a deal in a subcategory for one (or more) of the top “X” deals, the scores associated with those deals may be modified (such as by multiplying the score with a no-previous-purchase correction factor).

As shown in FIG. 3, the second iteration may account for particular business needs. Examples of business rules include, but are not limited to: rerunning a deal; deal de-duplicating; filtering targeted-only deals; and limiting extended access deals. Rerunning a deal may include running a deal previously run within a predetermined time period (such as 2 days ago, 2 weeks ago, etc.). The algorithm may be programmed with a business rule in which deals are shown to users who have not seen the deal before or who have not purchased the deal before. The time period the algorithm examines may look back in time a predetermined amount, such as 3 months. If the user has this deal as the top rank, and the user has seen this type of deal before (or has purchased this type of deal), then the user is shown something else.

Deal de-duplicating is a business rule that seeks to reduce sending of duplicate deals to a user. De-duplicating may come in one of several forms. One form is de-duplicating across a business (e.g., a particular business may be running two deals and the algorithm only shows the user one of them (w/in a particular time period). Another form is de-duplicating across the type of deal. It is possible to “clone” a deal, such as by issuing the same deal in multiple contexts (e.g., running a travel deal in getaways context workflow 1204 and the all deals context workflow 1202). The algorithm may account for a previous impression of a deal, and prevent a duplicate impression in a different context.

Filtering targeted-only deals may occur when certain deals are filtered or removed from consideration or scoring. Some deals may be designated for specific targeting and are not considered in scoring. These deals may be removed from the algorithm process and give special consideration. These specially considered deals may be tagged as such so that the algorithm does not analyze them.

Further, as shown in FIG. 3, the third iteration may account for balancing in which the final rankings are shuffled in order to meet desired feature placement constraints. For example, if it is desired that a certain maximum number or minimum number of people receive the deal offer, the algorithm may be modified or overridden. In particular, if it is desired that 500,000 people receive the deal offer, and the algorithm only selects 400,000 people, the algorithm may be modified (such as the thresholds to issue a deal offer, or a re-ranking of deals) in order to issue the deal to the 500,000.

FIG. 3 illustrates examples of iterations and potential correction factors. Other iterations and potential correction factors are contemplated. For example, an interaction accounting for price of a deal and a price correction factor may be used. In one embodiment, the scoring/ranking model 1500 (discussed below) scores and sorts deals based on the expected conversion rate. Price of the deals may be accounted thereafter by applying a price adjustment factor, whereby the predicted conversion rate is adjusted by the price of the deal (such by multiplying the predicted conversion rate by the price of the deal). In this way, the scoring and/or ranking of the deals may be used to increase or maximize revenue. Alternatively, the scoring/ranking model 1500 may account for price of the deals, as discussed below. As shown in FIG. 3, the scoring/ranking model initial scores the multiple deals. In still an alternate embodiment, the scoring/ranking model may be used after the initial scoring of the multiple deals, so that the scoring/ranking model may be used to adjust or modify previous scores or rankings.

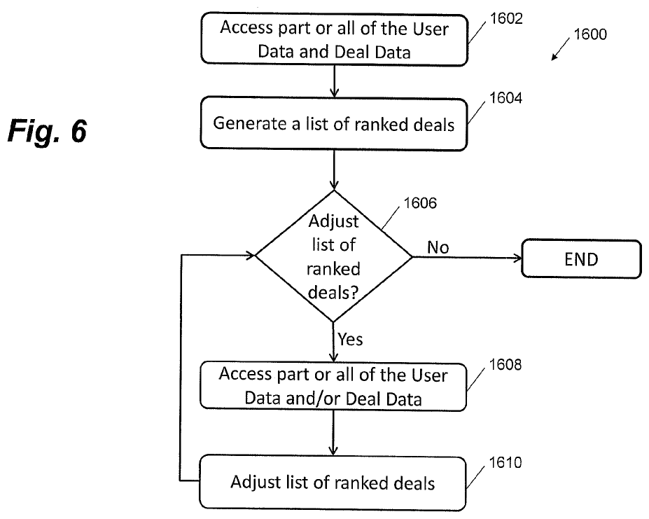

FIG. 6 illustrates a flow chart 1600 in which the list of ranked deals is iteratively reordered. At 1602, part or all of the user data and the deal data are accessed. At 1604, the accessed data is used to generate a list of ranked deals. At 1606, it is determined whether to adjust the list of ranked deals. If so, at 1608, data is accessed. The data may be the same type or a different type of user data and/or deal data than that accessed at 1602. At 1610, the list of ranked deals is adjusted based on the data accessed at 1608. The flow chart 1600 may then loop back to 1606 in order to determine whether to adjust the list of ranked deals again. In this way, the list of ranked deals may be iteratively re-ordered.

As discussed above, alternatively or in addition, the scores of the multiple deals may be iteratively modified. So that, one, some, or all of the initial scores for the deals may be adjusted or modified by accessing part or all of the user data and/or deal data.

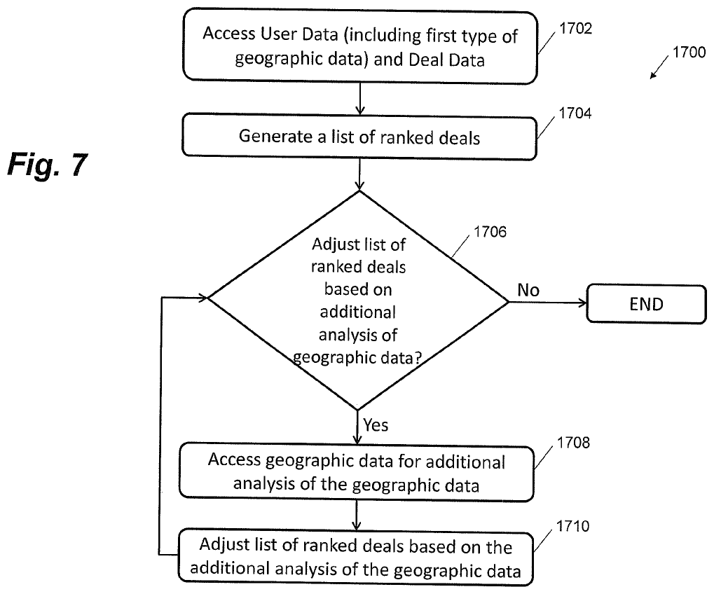

FIG. 7 illustrates a flow chart 1700 in which the list of ranked deals is iteratively reordered based on a same type of data, such as based on geographic data. At 1702, user data and the deal data are accessed. The user data may include a first type of geographic data. At 1704, the accessed data is used to generate a list of ranked deals. At 1706, it is determined whether to adjust the list of ranked deals based on an additional analysis of geographic data. If so, at 1708, geographic data is accessed for additional analysis. The geographic data may be the same type of geographic data accessed at 1704 or may be a different type of geographic data. At 1710, the list of ranked deals is adjusted or modified based on the additional analysis at 1708. The flow chart 1700 may then loop back to 1706 in order to determine whether to adjust the list of ranked deals again. In this way, the list of ranked deals may be iteratively re-ordered based on geographic data.

For example, user data and deal data may be accessed in order to determine a distance of a user to a particular deal (such as 2 miles from a deal). This distance information may be used by the scoring/ranking model 1500 in order to rank the particular deal, and to generate a list of ranked deals, such as illustrated in FIG. 3. After the list of ranked deals is generated, one or more other types of geographic data may be used to reorder, or modify, the list of ranked deals. As one example, business rules may use geographic data in order to modify the list of ranked deals. In particular, rules may include or exclude certain deals based on geography. In the case of deals in New York City, a business rule may state that a deal in one borough (such as Brooklyn) is excluded if the user is in another borough (such as Manhattan).

As another example of using geographic data, deal target locations may be used. Deal target locations are either user designated preference or system designated preferences of a geographic location (such as one or more zip codes) that may be interested in a specific deal. In particular, a deal may be offered in the coastal city of Half Moon Bay, Calif. The system may determine that users in the city of San Francisco may be interested in the deal offered, even though the distance is large enough that the scoring/ranking model 1500 would not rank the deal highly. In this instance, the zip codes (or other geographic information indicative of the city of San Francisco) may be used to indicate which users are in the city of San Francisco, and adjust the ranked deals accordingly to score the deal offered in Half Moon Bay higher. In this way, the system may target certain people even though the scoring/ranking model 1500 would otherwise not by modifying the output of the scoring/ranking model 1500 with another type of geographical data.

As still another example, one or more additional distance algorithms may be used to alter the list of ranked deals. In particular, a driving distance algorithm may be used to calculate the driving distance between the user and the deal. The driving distance algorithm may be different from the distance algorithm used in the scoring/ranking model 1500 (which may use a point-to-point calculation of the distance).

As discussed above, alternatively or in addition, one, some or all of the scores of the multiple deals may be iteratively modified based on a same type of data, such as based on geographic data. So that, the initial scores for the deals may be adjusted or modified by using business rules that analyze geographic data, using deal target locations, or using one or more additional distance algorithms to alter the scores for the multiple deals, as discussed above.

FIG. 7 illustrates a flow chart 1700 in which geographic data is used to initially score the deals (and/or initial ranking the deals), and in which the geographic data (which may be in a different form), is used to modify one, some or all of the initial scores of the deals (and/or to modify at least a part of the ranking of the deals). In an alternate embodiment, the relevance system 1014 may consider both geographically dependent deals and non-geographically dependent deals. One example of non-geographically dependent deals is an online deal, such as an e-commerce deal from a website. The e-commerce deal, which may relate to a hard good, may be shipped to the user so that the cost is not dependent on the location of the user. In this way, the non-geographically dependent deals do not depend on so that the conversion rates may be predicted regardless of distance or geography. Moreover, the scoring model 1510 may score deals that are dependent on distance and deals that are independent of distance. Thus, both types of deals (distance dependent and distance independent) may be considered. In the instance where only the best deal is provided to the user (such as sent in an e-mail), the best score for the deals, including both types of deals, may be considered. In the flow chart of FIG. 7, the scores of the distance independent deals may not be changed since the score of the distance independent deals will not be affected by the additional analysis of geographic data in 1708. However, the list of ranked deals may be adjusted at 1710 if the scores of other distance dependent deals in the ranking are affected.

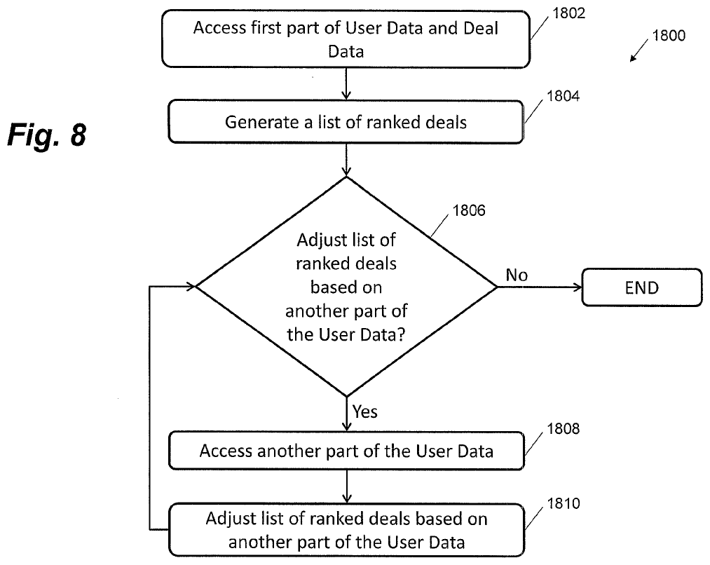

FIG. 8 illustrates a flow chart 1800 in which the list of ranked deals is iteratively reordered based on a different type of data, such as based on a different type of user data. At 1802, user data and the deal data are accessed. The user data may include a first type of or a first part of user data. At 1804, the accessed data is used to generate a list of ranked deals. At 1806, it is determined whether to adjust the list of ranked deals based on an another part or another type of user data. If so, at 1808, an additional part or type of user data is accessed. At 1810, the list of ranked deals is adjusted or modified based on the data accessed at 1808. The flow chart 1800 may then loop back to 1806 in order to determine whether to adjust the list of ranked deals again. In this way, the list of ranked deals may be iteratively re-ordered based on different parts of the user data or different parts of the deal data.

For example, user data and deal data may be accessed in order to determine a distance of a user to a particular deal (such as 2 miles from a deal). This user data and deal data may be used by the scoring/ranking model 1500 in order to rank the particular deal, and to generate a list of ranked deals, such as illustrated in FIG. 3. After the list of ranked deals is generated, one or more other types of user data may be used to reorder, or modify, the list of ranked deals. As one example, user designated deal types may be used to adjust the list of ranked deals. In particular, if the user has expressed an interest toward certain deal types, the scores associated with the deals in the list of ranked deals that have the expressed types may be modified (such as by applying a multiplier to bias to the expressed deal types). As another example, previous user purchase data (including deals that a user has just purchased) may be used to modify the list of ranked deals. An example of this is illustrated in FIG. 3. As still another example, user interest (such a user's open rate of previous e-mails and/or a user's click rate of links) may be used in order to modify the list of ranked deals.

As discussed above, alternatively or in addition, one, some or all of the scores of the multiple deals may be iteratively modified based on a different type of data, such as based on a different type of user data. So that, the initial scores for the deals may be adjusted or modified by using user designated deal types, using previous user purchase data, or using user interest to alter the scores for the multiple deals, as discussed above.

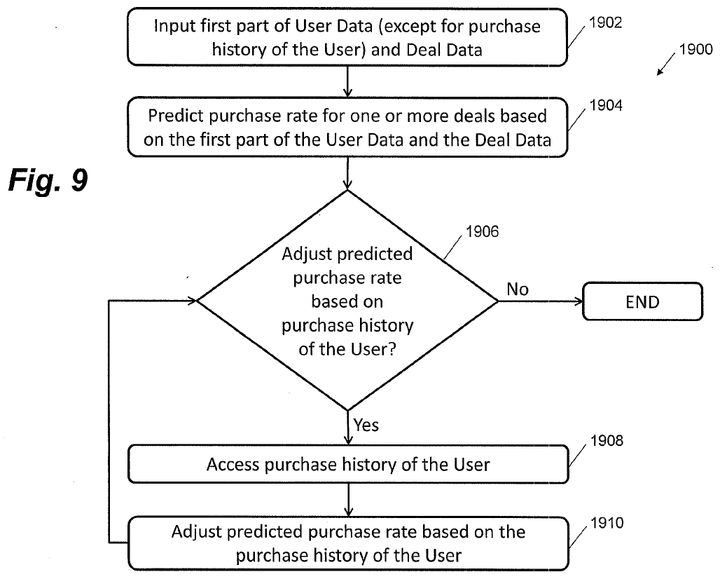

FIG. 9 illustrates a flow chart 1900 in which the list of ranked deals is iteratively reordered based on user purchase history. At 1902, user data (except for user purchase history) and the deal data are accessed. At 1904, the purchase rate is predicted for one or more deals based on the user data accessed at 1902. As discussed above, the scoring/ranking model 1500 may predict the purchase rate based on certain user characteristics, such as gender, location, and age. At 1906, it is determined whether to adjust the predicted purchase rate based on user purchase history. If so, at 1908, user purchase history is accessed for additional analysis. At 1910, the predicted purchase rate is adjusted or modified based on the accessed user purchase history. As discussed above, the predicted purchase rate affects the ranking of a deal so that a change in the predicted purchase rate may in turn affect a deal's ranking. The flow chart 1900 may then loop back to 1906 in order to determine whether to adjust the list of ranked deals again.

User purchase history may be used in one of several ways in order to modify the predicted purchase rate. As discussed above, the scoring/ranking model 1500 may be organized based on categories and subcategories. Likewise, the user purchase history may be organized into user purchases in categories and subcategories. The deal analytical engine 1100 may analyze the user purchases in the categories and subcategories in order modify the predicted purchase rate.

As one example, the deal analytical engine 1100 may determine whether a category or subcategory for a user purchase matches the category or subcategory of one of the deals in the ranked list of deals. If so, the ranking of the deals may be modified (e.g., the score of the deal may be increased to reflect a greater likelihood that the deal will be purchased).

As another example, the deal analytical engine 1100 may determine whether a correlated category or subcategory for a user purchase matches the category or subcategory of one of the deals in the ranked list of deals. The deal analytical engine 1100 may correlate certain categories or subcategories. The correlation may be directly proportional so that a user purchase in one category or subcategory indicates an increased likelihood of a purchase in the correlated category or subcategory. In particular, the subcategories of wine bars and opera events may be directly correlated so that a purchase in the wine bar subcategory indicates an increased likelihood of purchase in the opera event subcategory. Likewise, the correlation may be inversely proportional so that a user purchase in one category or subcategory indicates a decreased likelihood of a purchase in the correlated category or subcategory. In particular, the subcategories of exercise deals and fast food deals may be inversely correlated so that a purchase in the exercise deals subcategory indicates a decreased likelihood of purchase in the fast food deal subcategory. As discussed above, alternatively or in addition, the scores of the multiple deals may be iteratively modified based on user purchase history.

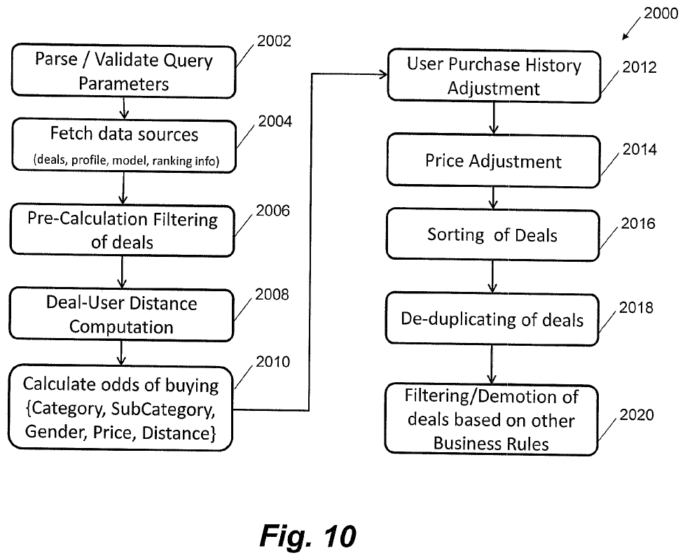

FIG. 10 illustrates a flow chart 2000 in which potential deals are scored and sorted. At 2002, the query parameters are parsed and validated. At 2004, different data sources are fetched, such as the deals, user profiles, deal analytical model(s) and ranking information. At 2006, pre-calculation filtering of the deals is performed. For example, prior to analyzing the deals, one or some of the deals may be filtered and removed from the analysis. The deals may be designated for another type of consideration. At 2008, the deal-user distance is computed. As discussed above, the user profile may include a user location (such as the user's home, the user's workplace, or another place as designated by the user). The distance between the user location and the deal location may be calculated. The distance may be calculated based on a point-to-point distance (or more colloquially, as the crow flies). Alternatively (or in addition), the distance may be calculated as the driving distance from the user location to the deal location. At 2010, the odds of buying the deal for the particular user may be calculated. As discussed above with respect to FIG. 5, the scoring model may use one of several inputs, such as the category of the deal, the subcategory of the deal, the price of the deal, the gender of the user, and the distance to estimate the likelihood that the deal is accepted by the user. One indication of the estimate is the conversion rate, as discussed above.

At 2012, an adjustment to the calculated odds is made using user purchase history. As discussed above, for example with respect to FIG. 9, the scores or ranking of the multiple deals may be adjusted using previous purchase history. At 2014, another adjustment is made to account for price. After which, at 2016, the deals are sorted based on the adjusted scores. As discussed above, the scores may be adjusted multiple times (as shown in FIG. 10) after which the deals may be sorted. Alternatively, the scores may be used to generate an initial list, with the scores and the initial list being adjusted iteratively. At 2018, the deals are de-duplicated in order to avoid duplicate impressions of the user. After which, at 2020, the deals are filtered/demoted based on other business rules. For example, depending on the minimum and maximum impressions of the deal desired, the deals may be filtered or demoted.

FIG. 10 illustrates the sequence for a single user and a single user location. Alternatively, batch processing may be used (such as discussed in FIG. 11) in order to process multiple users in batches.

In a further embodiment, a single user may ascribe himself or herself multiple user locations. The multiple user locations may include, for example, a home location, a work location, or another location where the user wishes to have deals targeted. Further, each of the multiple user locations may be used as a location for the flow chart of FIG. 10. In this way, the user may receive a top deal (or a top list of deals) for each of the locations.

Further, the user (or the relevance system) may ascribe a description to the location (such as a “home” location or a “work” location) or may ascribe certain types of deals desired at the location (such as “lunch deals” for the work location or “spa deals” for the home location). In the instance that a location is ascribed a specific definition (such as “work” location), the relevance system 1014 may use the description in order to adjust the scores or adjust the list of ranked deals. In the instance of a “work” location, for example, the relevance system 1014 may improve the scores of lunch deals (or reduce the scores of non-lunch deals) or may reorder the list of ranked deals to rank lunch deals higher.

FIG. 11 illustrates a block diagram of the inputs and outputs for the deal analytical engine 1100 when used to generate batch e-mails. As shown in FIG. 11, the deal analytical engine 1100 inputs a variety of information, such as deal information from the deal information database 1108, user information from the user information database 1110, and business rules from the analytical engine database 1112. Moreover, the deal analytical engine 1100 may receive input from impressions 2102, which may provide an indication of users' open rate of previous e-mails. As shown in FIG. 11, the impressions 2102 are separate from user information database 1110. Alternatively, impressions 2102 may be included in user information database 1110. The deal analytical engine 1100 may generate rankings 2104. The rankings 2104 may include a predetermined number of the top ranked deals (such as the top 1 deal, the top 5 deals, or the top 10 deals) for one, some, or all of the users on the batch e-mail listing. The rankings 2104 may then be used to configure e-mails to send to the users, with the e-mail including some or all of the top ranked deals.

FIG. 12 illustrates a flow chart 2200 for using different algorithms based on distance. Flow chart 2200 may be used in the context of travel deals, in which a user may travel to the deal. At 2202, the user data and the deal data may be input. The user data may include gender, location, and optionally age. At 2204, it is determined whether the distance between the deal and the user's location is less than a predetermined amount. If the distance is less than the predetermined amount, at 2206, the user data (such as gender), the distance, and the quality of the deal are used to score the deal. If the distance is greater than or equal to the predetermined amount, at 2208, the user data (such as gender) and the quality of the deal (but not distance) are used to score the deal.

For example, if the distance between the user and the travel deal is less than 200 miles, the distance is factored into the scoring of the deal since it is believed that a user will drive to the deal. If the distance is greater than 200 miles, the distance is not factored into the scoring of the deal since it is believed that a user will travel by airplane so that distance is less of a factor. Further, in one embodiment, the factoring of distance into the scoring of the deal may be constant (or have the same probability weighting) so that a deal that is 50 miles away from the user has the same weight as a deal that is 150 miles from the user.

As discussed above, the quality of the deal is factored into the analysis. The quality of the deal may be based on one of several things including: a manual input of a relative quality indicator; and/or a performance indicator (such as the conversion rate) for the type of user. In particular, the performance indicator may reflect statistics of the conversion rate of the deal for the previous users of the same gender, the same location, and the same age of the user. In particular, the performance indicator may be divided into geographical areas, with conversion rates determined in the different geographical areas. As one example, a travel deal in Chicago may have associated with it performance indicators in each state of the United States. This is due to variations in interest in traveling to a larger city, such as Chicago. Further, the scoring may also depend on: the newness of the deal (such as, for example, a bias toward scoring newer deals higher); a variety of deals. Moreover, similar to FIG. 10, the user purchase history, price adjustment, de-duplicating, and other business rules may be applied.

The goods context workflow 1206 relates to hard goods or product deals. In one embodiment, the hard goods are shipped so that distance is not factored into the scoring of the deal. In an alternative embodiment, the user travels to a store so that distance is factored into scoring. Scoring of a goods deal may be based on one or more factors, such as how successful the good is selling (e.g., the rate of sale versus the number of users notified of the goods deal); the gender of the user; and the location of the user. In particular, even if distance is not calculated, the location of the user may be factored into the scoring of a deal. The conversion rate for a particular goods deal may vary from region to region or from city to city. For example, a goods deal that is selling meat may be more popular in one region of the United States than another region.

The occasions context workflow 1208, discussed above, relates to deal associated with different occasions. Occasions may relate to any event or occurrence, such as a romantic occasion (e.g., Valentine's day) or a calendar event (such as February 29^{th} (leap year day). The occasion may be identified, such as by receiving input from the user, by identifying that the occasion is important to the user from the user's profile, and/or by determining whether the occasion is close in time. After identifying the occasion, a subset of the overall set of deals may be selected according to the occasion. For example, a subset of deals may be tagged as relating to a particular occasion, so that the subset may be evaluated.

The zero day context workflow 1212 may include a specific type of workflow based on an amount of interaction of the user with the relevance system. For example, when the relevance system determines that the use has not purchased his or her first deal, the user may access and examine a set of deals that may be different from the set of deals examined by a user that has purchased a previous deal.

The post purchase context workflow 1214 the same day that a consumer purchases a deal, such as in the same hour, or less than 5 minutes after purchase of a deal, the consumer is presented with at least one additional deal based on the same day purchased deal. For example, the last deal purchased may be emphasized in determining the next deal offered. In particular, at least one aspect of the last deal purchased, such as the category of the last deal purchased and/or the subcategory of the last deal purchased may be used to select the next deal offered. As one example, if the user purchased a mini-golf deal in San Francisco, one of the following may be suggested: golf lessons (6.9 miles away since the subcategory “leisure sports” is commonly bought with other purchases in “leisure sports”); go-cart racing (5.7 miles away since the subcategory “motor sports” is commonly bought with other purchases in “leisure sports”); or orange juice store (1.5 miles away since the scoring model gives a high score for the orange juice store deal and because it is nearby the purchase of the mini-golf deal). Thus, different factors may be used in order to determine the post-purchase suggested deal, including a deal in the same category and/or subcategory as the purchased deal, a deal in a correlated or related category or subcategory to the purchased deal, and/or a deal that is proximate (or within a predetermined distance) to the purchased deal.

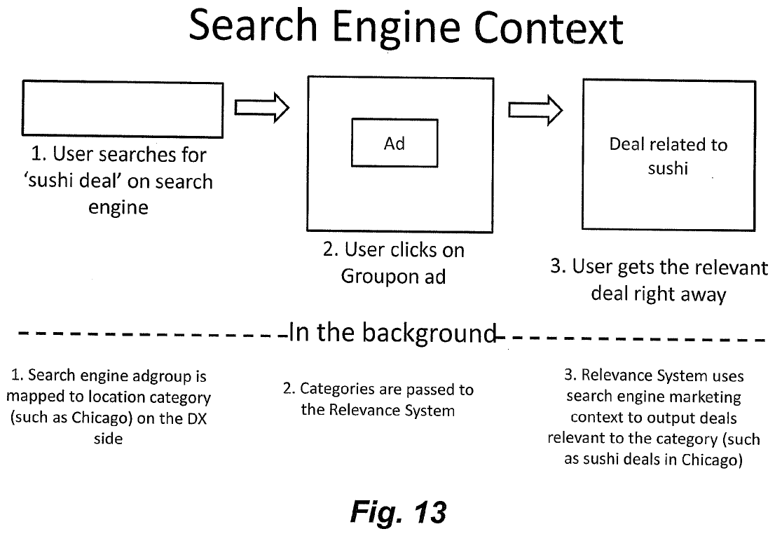

FIG. 13 illustrates a diagram of the processing for the search engine context. At step 1, the user inputs search terms into a search engine in order to search for a particular deal, such as a sushi deal. The search terms may be in the form of a text query. The search engine displays the results of the search. Typically, the search engine has certain keywords, such as “sushi,” that is mapped to an advertisement group, such as “sushi deals.” The advertisement group is then used to display an ad, such as the ad displayed in step 2. If the user clicks on the ad, the search engine may send the advertisement group and the general location of the user (as determined by the search engine) to the relevance system. Optionally, in addition, the search engine may send the exact search query, which may be used by the relevance system in order to further refine the intent/location of the request. In turn, the relevance system may map the advertisement group to a category or subcategory. For example, the advertisement group “sushi deals” may be mapped to the subcategory “sushi restaurants”. The relevance system 1014 may use the location of the user (as received from the search engine) to search the subcategory of sushi restaurants. In this way, the user does not need to key in additional information (separate from input keywords into the search engine) in order to receive a deal from the relevance engine 1014.

The mobile context workflow 1216 may vary from other contexts in one or more ways. For example, the mobile context workflow 1216 may take into consideration the real-time location of the mobile device (such as the latitude and longitude coordinates) in calculating the distance to a deal. Alternatively, or in addition, the mobile device context workflow 1216 may optimize around price point on the mobile device. In particular, the device communicating with the server may be indicative of the type of deals that the user will buy. Mobile device users may have different buying patterns than other users (such as users that use a home laptop or desktop computer to search for deals). In particular, mobile device users tend to buy lower priced deals, so that the algorithm in the mobile device context workflow 1216 may use a correction factor to increase the score of lower-priced deals and/or a correction factor to decrease the score of higher-priced deals.

The all deals context workflow 1202 may include general relevance criteria. Examples of general relevance criteria include, but are not limited to showing the best deals available at the request time (as opposed to being sorted by launch date of the deals).

In accordance with another aspect, the relevance system 1014 may be tailored or customized, including depending on: the specific context (such as discussed above with respect to FIG. 2B); the thresholds for the deal analytical engine 1100; throttling; geographic specific models; and geographic specific divisions. As discussed above, the deal analytical engine 1100 is configured to determine which deal(s) to present to the user. One or more thresholds may be used to determine whether and/or what deal(s) to present to the user. For example, a first threshold may comprise whether to send a notification to the user. As discussed above, the user may receive a notification in a variety of context, such as by e-mail. The first threshold may be a number that is compared with the scores of the multiple deals in order to determine whether or not to send the notification. The first threshold may varied based on the particular user and/or based on what deals may potentially be shown to the user. In particular, a particular user may be evaluated to determine an indication of reception to receiving deals. The determination of the indication of reception to receiving deals may be based on: click activity of the particular user to a received e-mail; e-mail impressions; and whether the user is likely to unsubscribe to e-mails. As discussed above with respect to FIG. 11, email impressions 2106 may be received to determine an indication of how receptive the particular user is to receiving e-mails. If the user does not, or rarely, opens the e-mails that include deals, it is an indication that the user is not receptive to receiving e-mails. Conversely, if the user frequently opens the e-mails that include deals, or clicks the links in the e-mail, it is an indication that the user is receptive to receiving e-mails. Further, a model may be used to predict a likelihood whether a user will unsubscribe to an e-mail. The model may use the user's previous activity in making the prediction.

Based on the indication of reception to receiving deals, the first threshold may be modified. For example, if the indication is that the particular user is less receptive to receiving deals, the threshold may be increased so that an e-mail is sent to the particular user only if the deals have a higher likelihood of acceptance. Conversely, if the indication is that the particular user is more receptive to receiving deals, the threshold may be decreased so that an e-mail is sent even if the deals have a lower likelihood of acceptance.

As another example, a second threshold may be used to determine what deal(s) to send to the user. Similar to the first threshold, the second threshold may be based on an indication of receptivity of the particular user to receiving deals. For example, if the indication is that the particular user is less receptive to receiving deals, the threshold may be increased so that only the deals with a higher likelihood of acceptance are sent to the particular user. Conversely, if the indication is that the particular user is more receptive to receiving deals, the threshold may be decreased so that deals with a lower likelihood of acceptance are sent to the particular user.

In another embodiment, throttling may be tailored. Throttling may vary the number of deals that are presented to the user (such as the number of deals in the notification to the user) and may vary the number of users that are sent the offer of the deal. For example, depending on the receptivity of the particular user to deals, the relevance system may throttle upward or downward the number of deals that the particular user is notified of. If the indication is that the particular user is less receptive to receiving deals, the particular user may receive fewer deals in the notification. Conversely, if the indication is that the particular user is more receptive to receiving deals, the particular user may receive a greater number of deals in the notification. As another example, depending on the sales of a particular deal, the number of users that are sent an offer to purchase the deal may be modified. For example, the receptivity of the deal itself and/or whether the deal is limited in the number of acceptances of the deal may impact the number of users that receive the deal. More specifically, if a particular deal is selling well and the particular deal has a limited quantity, the relevance system may reduce the number of users that receive notification of the deal. Or, the relevance system may apply a correction factor in order to reduce the score associated with the particular deal. Conversely, if a particular deal is selling poorly, the relevance system may increase the number of users that receive notification of the deal. Or, the relevance system may apply a correction factor in order to increase the score associated with the particular deal.

In yet another embodiment, geographic specific models may be used. The geographic specific models may include rules and/or scoring models that are tailored to different geographical regions, such as the New York City area, the Chicagoland area, or the Bay area. In another embodiment, geographic specific divisions may be used. The geographic specific divisions may have specific

In still another embodiment, the relevance system may provide the basis to the user by which the search was performed. In this way, the user may be informed of how the relevance system decided that the particular deal(s) be shown to the user. The basis may include, for example, the distance of the user from the deal, the previous purchases of the user, or the like. In addition, the relevance system may optionally receive feedback from the user in order to modify the search performed by the relevance system. In this way, the relevance system may perform iterative searches with the input of the user.

As discussed above, the relevance system may use one or more databases in order to determine which deal(s) to present to a user. In one embodiment, the relevance system may access an IP database, which correlates IP addresses to zip codes (or other geographic indication). In this way, if a user does not input a geographic indication (such as a zip code), the relevance system may still obtain the IP address of the user, correlate the IP address to a zip code (or other geographic indication), and use the zip code to select which deal(s) to present to the user.

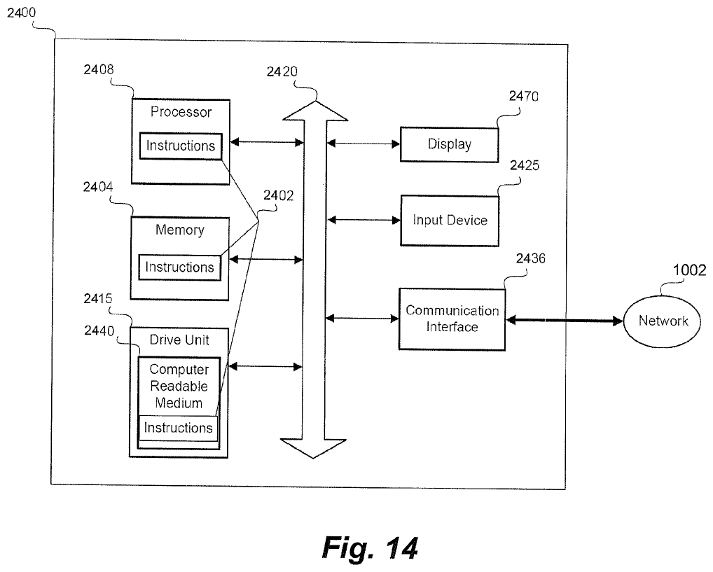

FIG. 14 illustrates a general computer system 1400, programmable to be a specific computer system 1400, which may represent any server, computer or component, such as consumer 1 (1004), consumer N (1006), merchant 1 (1008), merchant M (1010), Groupon® server 1012, relevance system 1014, search engine system 1016, and 3^{rd} party server 1018. The computer system 1400 may include an ordered listing of a set of instructions 1402 that may be executed to cause the computer system 1400 to perform any one or more of the methods or computer-based functions disclosed herein. The computer system 1400 may operate as a stand-alone device or may be connected, e.g., using the network 1102, to other computer systems or peripheral devices.

In a networked deployment, the computer system 1400 may operate in the capacity of a server or as a client-user computer in a server-client user network environment, or as a peer computer system in a peer-to-peer (or distributed) network environment. The computer system 1400 may also be implemented as or incorporated into various devices, such as a personal computer or a mobile computing device capable of executing a set of instructions 1402 that specify actions to be taken by that machine, including and not limited to, accessing the Internet or Web through any form of browser. Further, each of the systems described may include any collection of sub-systems that individually or jointly execute a set, or multiple sets, of instructions to perform one or more computer functions.

The computer system 1400 may include a memory 1404 on a bus 1420 for communicating information. Code operable to cause the computer system to perform any of the acts or operations described herein may be stored in the memory 1404. The memory 1404 may be a random-access memory, read-only memory, programmable memory, hard disk drive or any other type of volatile or non-volatile memory or storage device.

The computer system 1400 may include a processor 1408, such as a central processing unit (CPU) and/or a graphics processing unit (GPU). The processor 1408 may include one or more general processors, digital signal processors, application specific integrated circuits, field programmable gate arrays, digital circuits, optical circuits, analog circuits, combinations thereof, or other now known or later-developed devices for analyzing and processing data. The processor 1408 may implement the set of instructions 1402 or other software program, such as manually-programmed or computer-generated code for implementing logical functions. The logical function or any system element described may, among other functions, process and/or convert an analog data source such as an analog electrical, audio, or video signal, or a combination thereof, to a digital data source for audio-visual purposes or other digital processing purposes such as for compatibility for computer processing.

The computer system 1400 may also include a disk or optical drive unit 1415. The disk drive unit 1415 may include a computer-readable medium 1440 in which one or more sets of instructions 1402, e.g., software, can be embedded. Further, the instructions 1402 may perform one or more of the operations as described herein. The instructions 1402 may reside completely, or at least partially, within the memory 1404 and/or within the processor 1408 during execution by the computer system 1400. Accordingly, the databases 1106 may be stored in the memory 1404 and/or the disk unit 1415.

The memory 1404 and the processor 1408 also may include computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 1400 may include an input device 1425, such as a keyboard or mouse, configured for a user to interact with any of the components of system 1400. It may further include a display 1470, such as a liquid crystal display (LCD), a cathode ray tube (CRT), or any other display suitable for conveying information. The display 1470 may act as an interface for the user to see the functioning of the processor 1408, or specifically as an interface with the software stored in the memory 1404 or the drive unit 1415.

The computer system 1400 may include a communication interface 1436 that enables communications via the communications network 1002. The network 1002 may include wired networks, wireless networks, or combinations thereof. The communication interface 1436 network may enable communications via any number of communication standards, such as 802.11, 802.17, 802.20, WiMax, 802.15.4, cellular telephone standards, or other communication standards, as discussed above. Just because one of these standards is listed does not mean any one is preferred as any number of these standards may never actually be adopted in a commercial product.

Further, relevance system 1014, as depicted in FIG. 2A, may comprise one computer system or a multitude of computer system (each working in concert to provide the functionality described in FIG. 2A). Block diagrams of different aspects of the system, including FIGS. 1, 2A-5, and 11 may be implemented using the computer functionality disclosed in FIG. 14. Further, the flow diagrams illustrated in FIGS. 6-10 and 12-13 may use computer readable instructions that are executed by one or more processors in order to implement the functionality disclosed. Finally, the displays may be output on an I/O device, such as I/O Unit 255.

The present disclosure contemplates a computer-readable medium that includes instructions or receives and executes instructions responsive to a propagated signal, so that a device connected to a network may communicate voice, video, audio, images or any other data over the network. Further, the instructions may be transmitted or received over the network via a communication interface. The communication interface may be a part of the processor or may be a separate component. The communication interface may be created in software or may be a physical connection in hardware. The communication interface may be configured to connect with a network, external media, the display, or any other components in system, or combinations thereof. The connection with the network may be a physical connection, such as a wired Ethernet connection or may be established wirelessly as discussed below. In the case of a service provider server, the service provider server may communicate with users through the communication interface.

The computer-readable medium may be a single medium, or the computer-readable medium may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium may include a solid-state memory such as a memory card or other package that houses one or more non-volatile read-only memories. The computer-readable medium also may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an email or other self-contained information archive or set of archives may be considered a distribution medium that may be a tangible storage medium. The computer-readable medium is preferably a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

1.-16. (canceled)

17. A computer-implemented method of determining one or more consumer deals of a plurality of consumer deals to present to a consumer, the plurality of consumer deals associated with goods or services, the method comprising:
receiving contextual data regarding a consumer device, the consumer device associated with the consumer;
accessing one or more databases each containing a plurality of consumer deals;
determining, using at least one processor and based at least in pan on the received contextual data, a context under which to present at least one of the plurality of consumer deals to the consumer, the determined context selected from a plurality of contexts;
in response to determining the context, selecting a set of workflow rules under which to determine the one or more consumer deals of the plurality of consumer deals to present to the consumer;
analyzing, using the at least one processor the plurality of consumer deals based at least in part on the selected set of workflow rules;
based at least in part on analyzing the plurality of consumer deals, determining a selected one or more consumer deals of the plurality of consumer deals to present to the consumer;
generating an electronic correspondence comprising the selected one or more consumer deals; and
transmitting, using a communication interface, the electronic correspondence to the consumer device for presenting the selected one or more consumer deals to the consumer.

18. The method of claim 17, wherein determining the context comprises determining a presentation type of the consumer device that is to present the selected one or more consumer deals of the plurality of consumer deals to the consumer.

19. The method of claim 18, wherein the consumer device comprises a mobile device;
wherein the determined context comprises a mobile device context;
wherein another context is independent of the presentation type of consumer device; and
wherein the set of workflow rules selected for the mobile device context is different from the another context.

20. The method of claim 19, wherein each of the plurality of consumer deals includes price information; and
wherein the set of workflow rules selected for the mobile device context uses the price information differently than the another context in determining the selected one or more consumer deals from the plurality of consumer deals to present to the consumer.

21. The method of claim 17, wherein a deal service is configured to present the selected one or more consumer deals of the plurality of consumer deals; and
wherein determining the context comprises determining whether the consumer has ever purchased a deal with the deal service.

22. The method of claim 21, wherein another context is associated with a set of consumers that have purchased a deal from the deal service;
wherein, in response to determining that the consumer has never purchased a deal with the deal service, selecting the plurality of consumer deals from a set of consumer deals that is different from a set of consumer deals for the set of consumers that have purchased a deal from the deal service.

23. The method of claim 17, wherein the consumer has purchased a previous deal from a deal service;
wherein the deal service has issued the previous deal to the consumer;
wherein, in response to issuing the previous deal to the consumer, the determined context is a post-purchase context, and
wherein the selected set of workflow rules associated with the post-purchase context includes determining a subsequent deal to present to the consumer, the subsequent deal based at least in part on the purchased deal.

24.-28. (canceled)

29. An apparatus configured to determine one or more consumer deals of a plurality of consumer deals to present to a consumer, the plurality of consumer deals associated with goods or services, the apparatus comprising:
at least one memory; and
at least one processor in communication with the at least one memory, the at least one processor configured, in executing instructions, to:
receive contextual data regarding a consumer device, the consumer device associated with the consumer;
access one or more databases each containing a plurality of consumer deals
determine a context under which to present at least one of the plurality of consumer deals to the consumer, the determined context selected from a plurality of contexts;
in response to determining the context, select a set of workflow rules under which to determine the one or more consumer deals of the plurality of consumer deals to present to the consumer;
analyze the plurality of consumer deals based at least in part on the selected set of workflow rules;
determine a selected one or more consumer deals of the plurality of consumer deals to present to the consumer;
generate an electronic correspondence comprising the selected one or more consumer deals; and
cause transmission of the electronic correspondence to the consumer device for presenting the selected one or more consumer deals to the consumer.

30. The method of claim 17, wherein the plurality of contexts are one or more of an all deals context, a getaways context, a goods context, an occasion context, a search engine marketing context, a zero day context, a post-purchase context, or a mobile context.

31. The method of claim 17, wherein the determined context comprises a mobile device context and the contextual data comprises real-time location data of the consumer device.

32. The method of claim 31, wherein the selected set of workflow rules associated with the mobile device context includes analyzing the real-time location data to determine a distance between a current location of the consumer device and a deal location associated with each of the plurality of consumer deals.

33. The method of claim 17, wherein the determined context comprises a search engine context and the contextual data comprises text data associated with a search query.

34. The method of claim 34, wherein the contextual data further comprises location data.

35. The method of claim 18, wherein the presentation type of the consumer device comprises one or more of a mobile device, a palmtop computer, a laptop computer, and a desktop computer.

36. The method of claim 17, wherein determining the selected one or more consumer deals of the plurality of consumer deals to present to the consumer comprises:
generating a first relevance score for each consumer deal in the plurality of consumer deals;
ranking the plurality of consumer deals based at least in part on the generated first relevance scores; and
selecting one or more consumer deals of the plurality of consumer deals to present to the consumer based on the ranking of the plurality of consumer deals.

37. The method of claim 36, wherein the selected one or more consumer deals of the plurality of consumer deals is determined by comparing the ranking of the plurality of consumer deals to a predetermined threshold.

38. The method of claim 37, wherein the predetermined threshold corresponds to an indication of a level of receptivity of the consumer to receive consumer deals.

39. The method of claim 38, wherein in an instance the indication is that level of receptivity is low in comparison to a subset of other consumers, the predetermined threshold is increased such that the selected one or more consumer deals are associated with a higher likelihood of acceptance by the consumer.

40. The method of claim 38, wherein in an instance the indication is that level of receptivity is high in comparison to a subset of other consumers, the predetermined threshold is decreased such that the selected one or more consumer deals include one or more consumer deals associated with a lower likelihood of acceptance by the consumer.

41. The method of claim 36, the method further comprising:
accessing consumer data associated with the consumer;
accessing deal data associated with the plurality of consumer deals;
generating a second relevance score for each consumer deal in the plurality of consumer deals based at least in part on the deal data and the consumer data; and
updating the ranking of the plurality of consumer deals based on the generated second relevance scores.
